(19) United States
(12) Patent Application Publication
(10) Pub. No.: US 2004/0107134 A1
(43) Pub. Date: Jun. 3, 2004

(54) Reward based health care compensation system and method

(76) Inventors: Jeff A. Nelson, Stillwater, MN (US); Tony Anastasia, Minneapolis, MN (US)

Correspondence Address: Beck & Tysver, P.L.L.C., Suite 100, 2900 Thomas Avenue S., Minneapolis, MN, 55416, US

(21) Appl. No.: 10/307,852

(22) Filed: Dec. 2, 2002

(51) Int. Cl. G06F 17/60

(52) U.S. Cl. 705/14

(57) ABSTRACT

A business method which provides a financial incentive to health care providers who meet pre-established criteria. The method of determining the amount and the availability of the incentive payment is carried out with a methodology that also provides for return of the incentive payment if health care providing organizations do not qualify for the payment.

### FIELD OF THE INVENTION

The present invention relates generally to a business method for determining the availability and the amount of an incentive payment to improve health care provider performance.

### BACKGROUND OF THE INVENTION

The prior art, the limitations of the prior art and the differences between the prior art and the invention are made clear by reference to figures showing the relationships between health care providers, health care purchasers, and health care consumers.

FIG. 1 is a graphic that compares the invention to the prior art. The figure shows the progression of health care payments or costs, over time, based on current compensation practices. In the figure a base payment “B” is provided to a health care provider. This payment is intended to compensate the health care provider for the medical services rendered to a patient. The increment “A” is additional “incentive” compensation determined using the current payment methodologies. In the figure, the health care purchaser treats the total payment A+B as the cost of care. Selected health care providers receive the incremental amount “A” in addition to the payment “B”. One limitation of this prior art system is that the incremental payment is largely uncoupled to the performance of the provider. The amount is not meaningful in comparison to the total revenue received by the heath care provider and it is not coupled directly to the performance of the provider.

In general, the incentive payments are made periodically to health care providers who have been determined to perform well in the statistical sense after the fact. This hindsight evaluation of heath care provider performance does not require the participation of the heath care provider and they are not informed prospectively of those actions that they may take to receive the incentive payment. As a consequence they pay little attention to this revenue source. In most instances the payments are not delivered close in time with the basic compensation and are not correlated with any particular identified action taken by the provider. Under prior art methodologies this incremental amount is “committed” in the sense that it is a fixed fraction of an already paid for health care premium, and the only question is which among may potential recipients will receive the incremental payments. For these reasons the traditional incentive payment does not effectively motivate the health care providers to improve.

The typical incentive payment is now about 1-2% of the total premium paid by a purchaser. By way of contrast, the adoption of the invention should result in a comparative payment profile seen in the figure as base payment “D” supplemented by an “incentive” payment “C”. In general the incentive amount “C” is a growing percentage of the total compensation over time and it is expected to be about 10% initially. Over time, the rate of increase of the base payments “D” is suppressed as a result of the adoption of the practices that give rise to the incentive or “bonus” payment “C”. However, only if health care provider performance improves is the optional payment “C” made and then only directly to that health care provider that prospectively qualified for the optional payment.

FIG. 2 shows the typical set of relationships in a prior art health care system for a conventionally insured employers. The figure shows a representative employer or health care purchaser (EHCP) as 10. It should be understood that most health care in this country is provided based on the employer/employee relationship, however other health care purchasers are within the scope of the invention and the term employer and health care purchaser must be understood to cover unions, school districts and other types of purchasing entities.

The employer or EHCP 10 has many employees illustrated in the figure by representative employees 12 and 14 each of whom are both employees of employer 10 and patients of the health care provider (HCP) 18. The affiliation or employment relationship between the persons receiving medical services and the purchaser 10 is shown as dotted line 11 grouping the EHCP 10 with the patients.

In general, the employer 10 contracts with an insurance company shown as payer 20 to mange the delivery of heath care to the employees. The payer 20 will collect a premium 30 from the EHCP 10 and make payments 22 to the provider 18 as patients 12-14 receive medical services 26 respectively.

In this model the employer pays the premium 30. The payer 20 makes a basic payment 22 for covered health care. The premium includes a profit margin for the payer 20. The insurance company may create a performance enhancement program which will allocate additional funds to pay an incremental amount 24 to the health care provider under certain circumstances.

In most instances the incremental amount is determined by a “Disease Management Company”, or DMC 21. The disease management company 21 (DMC) may be affiliated with the payer or it may be a division of the payer 20 who makes the incremental payment.

A representative methodology for creating an incremental payment is shown within the DMC 21. The DMC may look out over the universe of heath care providers that they have access to and plot the “provider performance” against the number of providers with specific measured performances. Typically a bell shaped curve or normal distribution of performance is obsereved. The DMC may make an incremental payment 24 to a HCP 18 that is approximately (for example) one standard deviation 25 from the mean performance 23.

However, from the purchasers standpoint the payment 24 is not optional since it is taken from the premium 30. Not all HCPs will qualify for the payment but none will know in advance what actions they may take to receive the payment. The payment is awarded retrospectively without participation of the HCP and cannot therefore incentivise the HCP. Typically the recipient may vary from time to time as the relative performance of the HCPs moves. The conventional prior art self insurance model is similar to the system presented in FIG. 2.

In either system the fundamental drawback is that the cost to the employer is increased by the amount of the incremental performance payment. Incentive payments represent increased cost of health care. From the health care providers' perspective the performance payment is inconsequential, and fundamentally decoupled from the delivery of service.

The current system does not provide motivation to health care providers to improve their performance. Heath care purchasers witness increased costs with no corresponding improvement in patient health.

### SUMMARY OF THE INVENTION

In contrast to the prior art systems, the present invention creates a managed pool of financial resource. This pool is the primary partnership asset held by a limited partnership that includes the employer as a limited partner and a reward health care partner (RHCP) as a general partner. In the preferred partnership entity all the financial resource comes from the limited partners and the various reward pools are administered by the RHCP.

The performance based payments are taken from the pool and they are only paid to health care providers who meet announced criteria related to HCP provider performance. These metrics of heath care performance are provided to HCPs in advance of a performance measuring period. Periodically any pool money not distributed is returned to the employer less the management cost of the RHCP.

The preferred structure of this system includes a partnership, or partnership-like relationship between the employer/health care purchaser and a reward manager entity. The partnership relationship allows funds, letters of commitment or other forms of financial commitment to be placed in the pool to be carried as an asset “capital” rather than treated as an expense from an accounting perspective. This preferred legal structure also permits the tax-free return of “capital” if pool funds are not awarded. It is likely that the poll will be funded in part by letters of commitment or other non-cash financial instruments. It is not the intention of the relationship to make money management itself a major activity of the RHCP.

The award creation and approval system is implemented with computers, algorithms and communication links and relies on interaction with new and existing databases. The overall architecture and structure of the organization permits the heath care provider to determine if they qualify for a performance reward using tools and metrics supplied to the HCP from the reward health care partner (RHCP). This structure reduces overhead and administrative delay and duplication of staff for the creation and payment of the performance reward.

### BRIEF DESCRIPTION OF THE DRAWINGS

In the figures identical reference numerals are used to show identical or equivalent structures in the various figures, wherein:

FIG. 1 is a chart comparing the prior art care system with the invention;

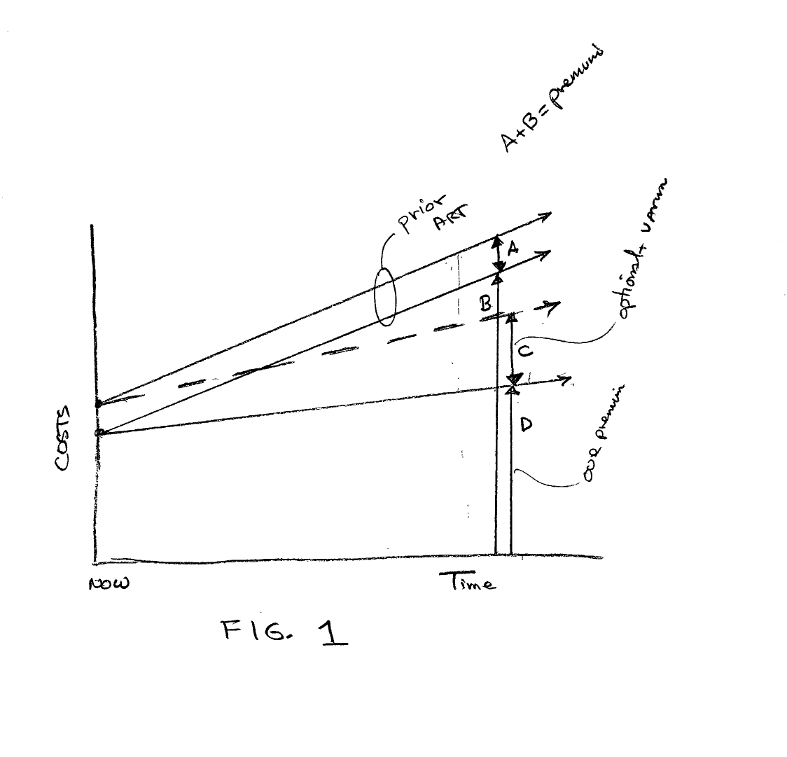

FIG. 2 is prior art heath care system architecture as practiced by an insured health care purchaser;

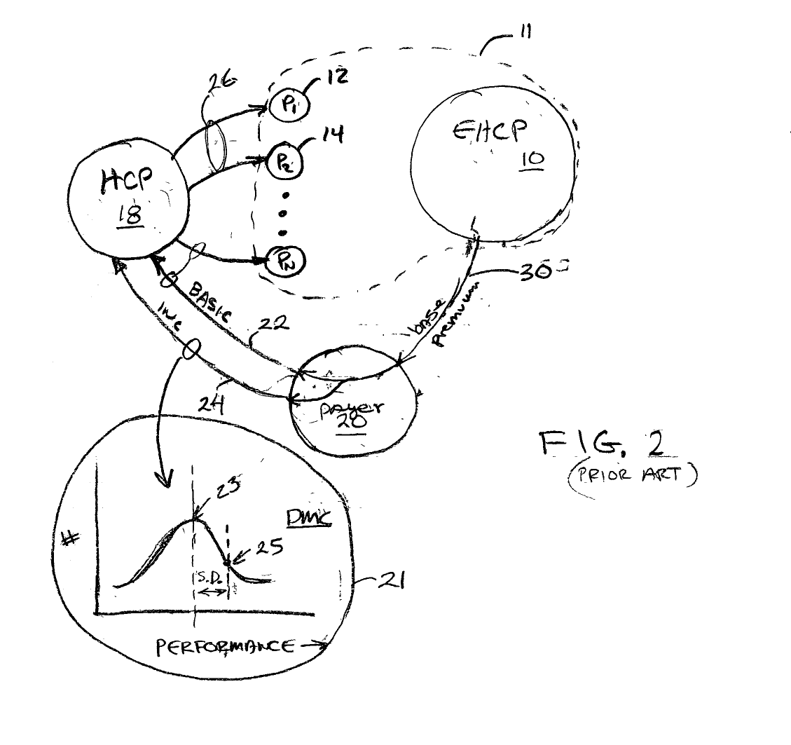

FIG. 3 is a relationship diagram depicting the invention;

FIG. 4 is a chart showing a more complex set of pools and EHCPs;

FIG. 5 is a flow chart representing the methodology to determine the availability of and the amount of a payment out of the pool;

FIG. 6 is a representative screen shot of a database creation tool; and,

FIG. 7 is a graphic representation of a criteria and the benchmark.

### DETAILED DESCRIPTION OF THE DRAWINGS

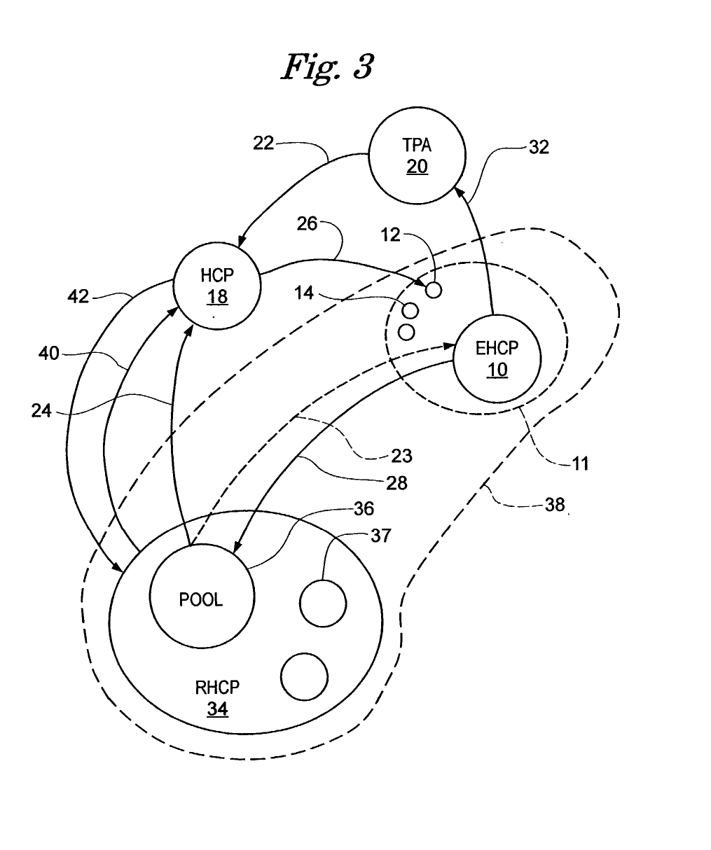

FIG. 3 shows the relationships between parties and actions in the inventive reward system and methodology. In the figure, an employer or heath care purchaser is represented by entity 10. Representative employees of employer 10 are labeled 12 and 14 in the figure. Dotted line 11 groups these particular employees with employer 10.

A representative employee 12 has received medical care 26 from a health care provider 18. The HCP 18 may be a physician practice group or other entity providing treatment to the employee/patient 12. In this version of the invention, the employer 10 contracts with a payer 20 to administer a basic payment for the medical services 26 rendered to the patient 12. This basic payment 22 from the payer 20 to the HCP 18 is passed through to the employer 10 and is shown as payment 32.

An additional incentive payment 24 may be made to the HCP 18 from a pool 36 administered by a reward heath care partner (RHCP) 34. The pool is funded by a contribution of capital or financial encumbrance illustrated as “payment” 28. On periodic basis money not paid to the HCP as an incentive payment 24 is forgiven or otherwise returned to the ECHP 10 as indicated by dotted “payment” 23. Thus a payment, not paid to the HCP 10 is returned to the EHCP 10 as seen by payment 23. One benefit of this structure is that the money 28 contributed to the pool 36 is not an expense unless paid via payment path 24. A return of capital via payment path 23 is untaxed and the original contribution 28 is not an expense. These taxation and accounting advantages obtain if the RHCP 34 and the EHCP 10 are in a partnership, LLC or LLP relationship as shown in the figure by dotted grouping 38. Although the invention is most easily explained using a “cash” model it must be understood that credit and other financial instruments may be created to meet the funding requirement of the pools.

In general the RHCP 34 will be the “general partner” and the EHCP 10 will be a limited partner in the partnership like entity 38. The RHCP 34 has a fiduciary obligation to the limited partner with respect to the management of the funds of the pool 36.

The simplest case is shown in the figure where the partnership-like entity 38 has only two partners, the limited partner EHCP 10 and the general partner RHCP 34. The pool 36 reflects the contributions of a single EHCP. More complex arraganements are possible and desirable.

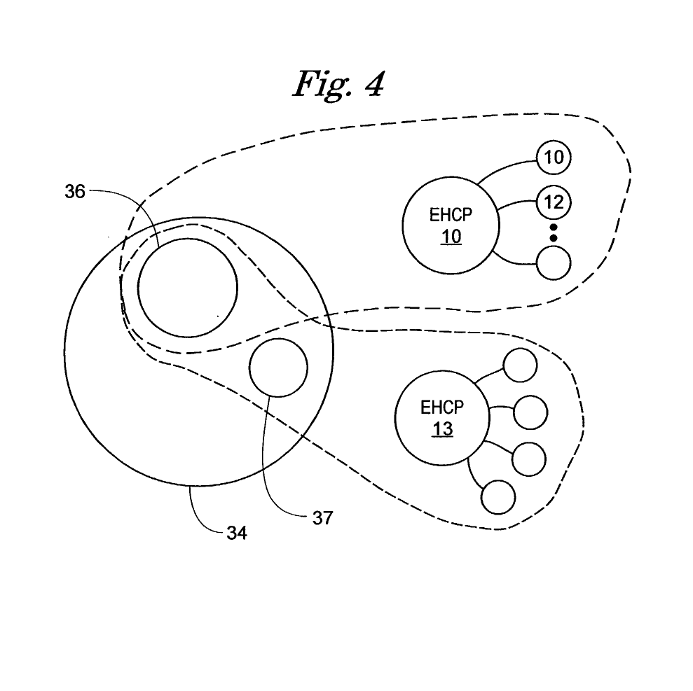

FIG. 4 is one configuration where the pool 36 is shared by two employer/health care purchasers shown as EHCP 10 and 13. In this instance the pool 36 is administered by the general partner RHCP for the benefit of all limited partners. In the same figure the pool 37 is selected by only one employer 10. In this diagram multiple employees share a pool shown as pool 36 and one employer 13 has selected membership in two pools, illustrated by pool 36 and pool 37.

In this example the RHCP 34 may administer several sub-pools directed to various disease states. For example, congestive heart failure, coronary artery disease and diabetes are potential sub-pools. The organization of the pools around a disease is solely for illustration and ease of discussion. It must be understood that other goals can be set up for a pool. For example, the adoption of a particular medical or information management technology, or other program or methodology to accelerate improvements in the quality of health care, may be the focus of a pool.

Preferably a relatively large number of employers join the partnership master pool and sub-pools are organized to more nearly reflect the disease states of their employee patient populations.

In a typical configuration there will be multiple pools with each pool directed to a specific disease or other focus. Each pool will have multiple limited partners contributing money to the pool. The RHCP will serve as the general partner and manager for each pool. In its administrative capacity the RHCP will provide tools including software to the HCP to track the performance and the applicability of performance payments as illustrated in FIG. 3 by tool transfer 40. The tools are used to determine if a performance based payment is warranted and if so the HCP sends a request for a payment illustrated by request message 42.

In this architecture the RHCP operates not as a third party administrator processing claims or contracting with the provider networks, but solely as the manager of the pools and pool payments. The conventional claim system continues to be performed by the insurance provider of the system.

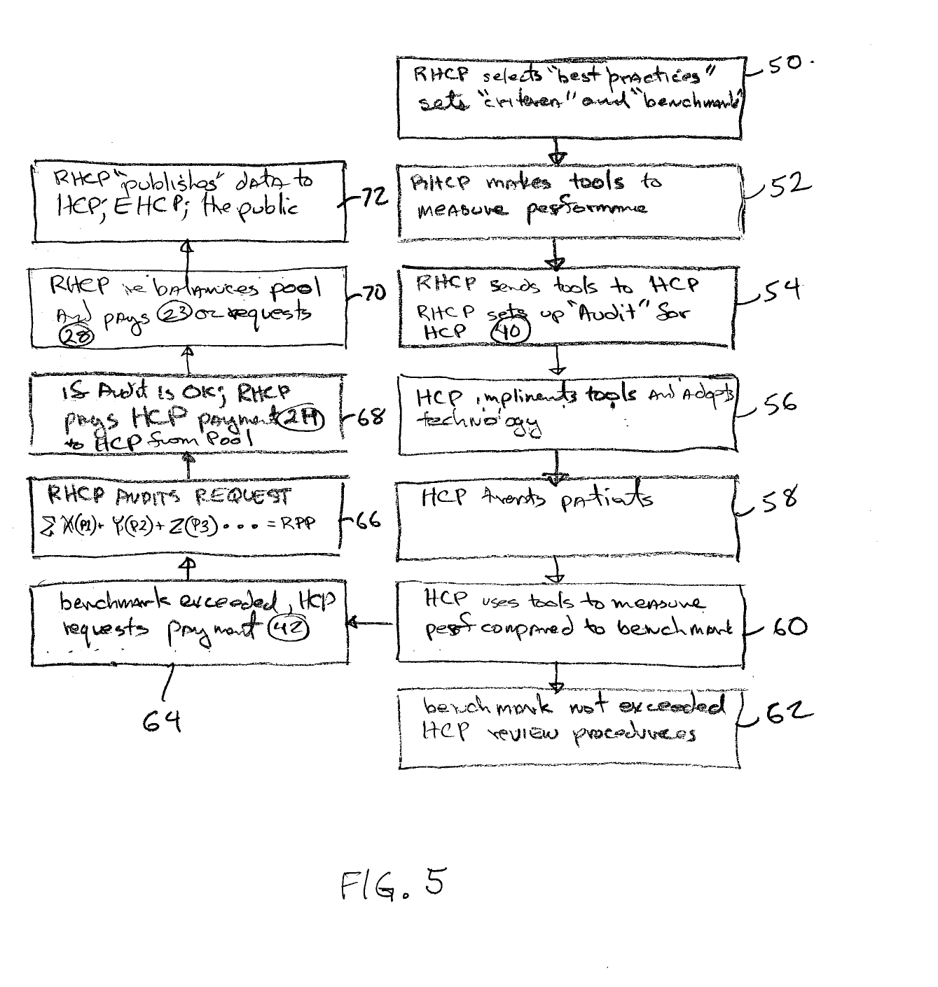

The system relies upon communication links between the illustrative entities and although these may take many forms, it is preferable to have a computer implemented computation and communications system to ensure that all of the requisite data is taken and distributed to the appropriate entities. FIG. 5 and FIG. 6 and FIG. 7 should be considered together. FIG. 5 shows a representative methodology to implement the invention. Processing steps involve several entities and in general the communication can occur between entities through a shared database or web based communication. Other forms of communication are permitted as well but not illustrated in the figures.

FIG. 5 shows a flow chart for the implementation of the method. For purposes of illustration reference is made to a single disease pool directed to diabetes treatment as an illustrative but not limiting example. The methodology is independent of the particular disease or pool emphasis selected. For this reason the figure should be interpreted as exemplary and not limiting. Diabetes is well known and it has been selected for ease in explanation of the method.

In FIG. 5 the process begins with the investigation of best practices by the RHCP who uses the available information to set up both “criteria” and “benchmarks” in step 50. A criteria may be a particular task that the RHCP has identified as important for the treatment of diabetes. For example the RHCP may want to encourage 100% screening for A1c level for all patients covered by a pool. This would be screening criteria. The RHCP may also want to ensure that patients can quickly see a doctor within the HCP. Suitable criteria may be the number of appointments available to patients on a monthly basis. This would be an access criterion. The RHCP may want to encourage education of the patient population in the importance and use of blood sugar monitoring devices. This may be called a treatment criteria and it may be set up for the delivery of monitoring devices to patients. Benchmarks on the other hand are measures of performance for each criteria. For example a goal of 100% screening of the patient population within a year may be a benchmark for the screening criteria. A benchmark for device use may be 100% usage for treatable patients. The precise criteria and benchmarks will vary from disease to disease and may be non-clinical in the case of the adoption of technology. The important characteristic of the criteria and benchmarks are that they are defined in advance and communicated to the HCP so that they may adapt their programs and practice procedures to address the criteria.

Step 52 the RHCP formulates tools to allow the HCP to monitor their own performance with respect to criteria and benchmarks. The same tools will be used by the RHCP to audit performance as compared to benchmarks.

Step 54 involves transferring the tools to participating HCPs and configures the tools to operate within the HCPs business. For each participating HCP, the RHCP sets up an audit function in step 54 to determine the appropriateness of a reward pool payment to the HCP. The tools provided by the RHCP to the HCP may take any of a number of forms but the primary deliverable will be software to track the management of the disease and to create a database that reflects the treatment of the patients.

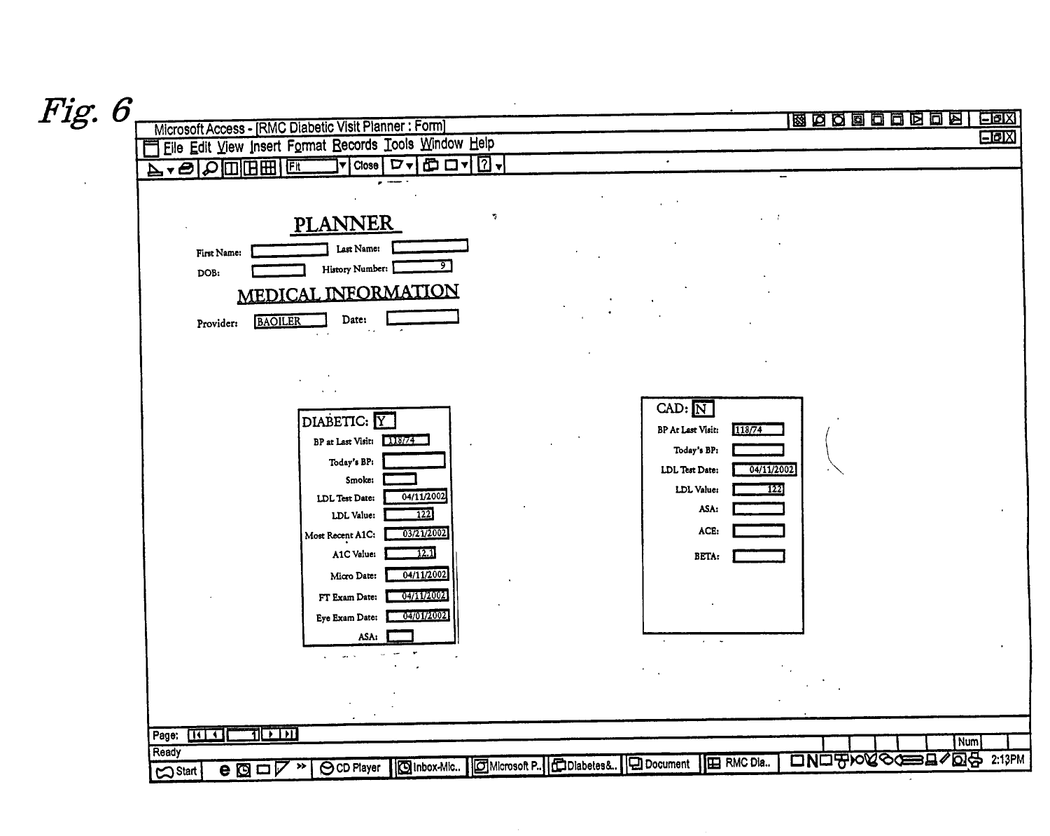

In step 56 the tools are implemented and the example screen shot of FIG. 6 is an exemplary data input screen to a database maintained by the HCP in response to the delivery of the tools in step 56. The software tool may require the entry of “A1c” levels or any other marker for diabetes at each patient visit.

In step 58 the HCP treats the patients of the pool and the data related to performance against benchmarks for each criteria is generated.

In step 60 the HCP monitors its own performance against the criteria and benchmarks. The tools will allow the HCP to compute a reward pool payment based on their performance. The algorithm will be known to all the participants and it is shown explicitly in step 66. If the benchmarks are exceeded, then the process moves to step 64 where the HCP requests a payment (see 42 in FIG. 3) from the RHCP.

In step 62 the HCP will review and revise its procedures if the measured performance does not meet the benchmarks.

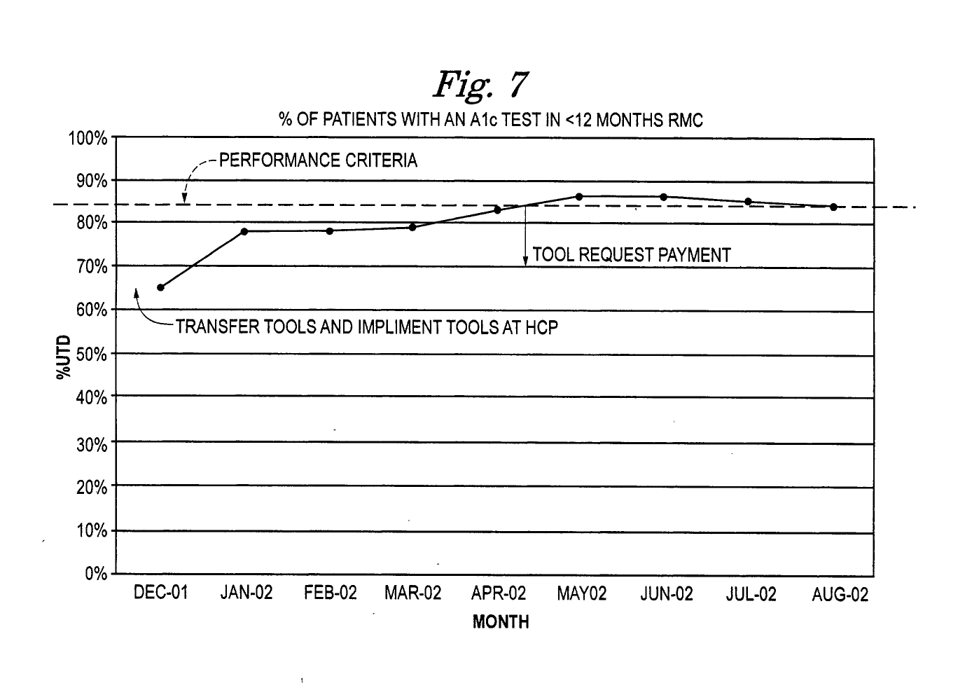

FIG. 7 represents a trajectory of a hypothetical screening operation carried out in step 58 where the tools are in place and in use. If a benchmark or metric is reached the tools will help the HCP to issue a request for payment.

In step 66 the RHCP evaluates a request for a payment. A payment will be issued if appropriate. The methodology to compute the reward payment from the pool may take any of several forms. In general each performance parameter will be given a weight that reflects its importance in the opinion of the RHCP. For example in the equation shown in step 66 shows that the reward pool payment is the sum of several individual factors. In this illustrative example the value of the weighting factor X may be 0.9 showing the importance of criteria P1. For example this may reflect the percentage of screening the patient population as seen in FIG. 7, weighting factor “Y” may be 0.1 and reflects the relatively less importance of screening of the population within one year. The final expressed weight “Z” may be 0.5 reflecting the value placed on the adoption of the software tool seen as screen shot of FIG. 6. In this exemplary calculation the total amount of a payment reflects satisfaction of criteria and level of performance against the announced benchmarks. The calculation is not necessarily complete and it must be understood that the goal of the reward pool payment process is to secure improved compliance of the HCPs with the goals of the PHCP.

In step 68 the amount of the proposed RPP is audited and paid if appropriate according to the audit.

In step 70 the pool is periodically rebalanced and further financial commitments for the EHCP are sought if required. In the event that the pool is over funded promises to pay are forgiven or monies re-distributed to the EHCP as set forth in the partnership agreement.

In step 72 the RHCP publishes its data to the HCP and EHCPs. The goal is to make the reward pool distribution process very transparent to encourage participation by both HCP and EHCPs.

What is claimed is:

1. A method of calculating the amount of and the availability of a reward incentive payment comprising:
forming a partnership entity combining a reward health care partner (RHCP) with one or more employer/heath care purchasers (EHCP), of the type having employees or members;
accepting financial commitments from the EHCP into the entity, establishing an interest in a reward pool;
establishing performance criteria, and benchmarks for the reward payments from the reward pool;
providing criteria, benchmarks and tools to participating health care providers (HCP) from the RHCP;
determining by the HCP if the HCP performance exceeds the benchmark criteria resulting is a proposed RPP;
notifying the RHCP when and if benchmark criteria are exceeded:
auditing the HCP request by the RHCP and computing and remitting a performance reward payment to the HCP when the benchmark criteria are exceeded.

2. The method of claim 1 further comprising:
periodically re-balancing the reward pool and returning capital or forgiveness of a financial commitment to an employer if HCP does not exceed the benchmark criteria.

3. The method of claim 1 wherein:
the computing step comprises multiplying a weighting factor with a performance index and summing over a set of factors to compute an award amount.
